(19) United States
(12) Patent Application Publication
(10) Pub. No.: US 2014/0132750 A1
(43) Pub. Date: May 15, 2014

(54) LIGHTING APPARATUS FOR MEASURING ELECTRONIC MATERIAL-PROCESSED PART AND TEST APPARATUS USING THE SAME

(71) Applicant: ADVANCED TECHNOLOGY INC., Incheon (KR)

(72) Inventors: Doo Hyun YOON, Incheon (KR); Doo Baeck An, Incheon (KR); Jin Young Kim, Incheon (KR)

(73) Assignee: ADVANCED TECHNOLOGY INC., Incheon (KR)

(21) Appl. No.: 13/742,321

(22) Filed: Jan. 15, 2013

(30) Foreign Application Priority Data
Nov. 13, 2012 (KR) 10-2012-0127934

(51) Int. Cl. F21V 7/00; H04N 7/18

(52) U.S. Cl. CPC F21V 7/00; H04N 7/18
USPC 348/87; 362/235

(57) ABSTRACT

The present invention relates to lighting apparatus for measuring an electronic material-processed part and the test apparatus using the same. The lighting apparatus includes a dome reflection plate 12 disposed over the subject of measurement and configured to have a dome form, have a light inflow window 11 through which coaxial illumination enters or exits formed at a central part of a highest end of the dome reflection plate 12, and have incident light reflected in all directions within the dome; a plurality of dome illumination lamps 13 disposed at lower edge portions of the dome reflection plate 12 and configured to illuminate the inside of the dome; and a camera 20 disposed right over the light inflow window 11 for the coaxial illumination of the dome reflection plate 12. The lighting apparatus illuminates a processing part, that is, the subject of measurement.

### CROSS REFERENCE TO RELATED APPLICATION

This application claims the benefit of Korean Patent Application No. 10-2012-0127934, filed Nov. 13, 2012, which is hereby incorporated by reference in its entirety into this application.

### BACKGROUND OF THE INVENTION

1. Technical Field

The present invention relates to lighting apparatus for measuring an electronic material-processed part and a test apparatus using the same and, more particularly, to lighting apparatus for a test apparatus for testing the degree of precision of a processed part and whether there is a defect or not when producing a variety of electronic materials or parts. In particular, a substantial example of the present invention relates to lighting apparatus and a test apparatus using the same for checking a minute scar in a processing part (e.g., a sawing line) that is formed by a diamond sawing process for cutting a semiconductor wafer.

2. Description of the Related Art

A substrate cutting and separation method is used to separate a fragile substrate, such as glass, silicon, or ceramics, into parts by cutting the fragile substrate. Cutting methods, such as scribing, blade dicing, laser cutting, stealth dicing, and Thermal Laser Separation (TLS), are being used as the substrate cutting and separation.

Cutting methods, such as scribing, blade dicing, and laser cutting, are being used as a method of separating a fragile substrate, such as glass, silicon, or ceramics, into parts by cutting the fragile substrate. Here, the scribing and blade dicing methods are mechanical cutting methods, and the laser cutting method is a non-contactless cutting method using a laser.

A laser drilling or laser ablation process is used in a common laser cutting method. In the laser drilling process, there is a problem in that melt or evaporated silicon particles are adhered to a surface of a substrate. In contrast, the laser ablation process using an excimer laser or a femto second laser is advantageous in that the amount of particles generating during a process can be minimized because the material of a substrate is physically evaporated.

As described above, the substrate cutting method using a laser can solve a variety of problems occurring in the mechanical cutting method. In the industry field, however, the mechanical cutting method is being used a lot owing to a price problem. Furthermore, whether there is a defect or not or a cutting state is checked by precisely testing the subject of cutting in mechanical cutting.

A process of obtaining the data is described in more detail by way of a diamond sawing process of forming a circuit in a semiconductor wafer and cutting the semiconductor wafer in a proper size. There are a variety of methods of obtaining data or information used to test the width of a crack, chipping, or a processing part (e.g., a sawing line, that is, the processing part of a wafer) generated in a product and an angle of a processing part by using image data obtained by the above-described method or a variety of other methods.

Most of conventional methods used to obtain a precise image are problematic in that illumination thereof is weak. In order to obtain a precise image, light must uniformly light up all the portions of a sawing line, that is, the subject of measurement. However, to illuminate all the portions of a sawing line uniformly is difficult.

As shown in FIGS. 1 and 2, there are a variety of problems occurring during a diamond sawing process. Although a wafer is precisely cut, environmental factors and mechanical defects appear when an image of a cut sawing line is enlarged with ultra-high precision.

A wafer is a thin plate. In this thin plate, a circuit for fabricating the plate into chips has been subjected to light exposure, and the plate must be cut into a proper size. Reference numeral ‘3’ indicates a sawing line (i.e., a cutting line). The sawing line 3 is cut in the state in which a large number of chips 20 can be produced from one wafer 2 when designing the chips 20. This method is performed by a diamond sawing process. An image of a cutting plane is obtained and processed, and a magnified figure of the processed image is shown in FIG. 3.

The sawing line 3 of FIG. 3 shows that the sawing line is not cut in a perfect straight line when an image of the sawing line 3 is obtained and processed. When the image is magnified at high magnifications, the sawing line 3 is cut like a curved line 21 indicated by a dark solid line. A worker had intended to cut the sawing line 3 in the form of a straight line indicated by a dotted line 22, but the sawing line was cut in the form of a curved line due to several factors. This can deteriorate the quality of the chips 20 and can also become a cause of a defect.

FIG. 2 shows the greatest width in which a cutting line gets out of the most preferred sawing line 3 and invades into a margin direction. A portion ‘B’ indicates a minimum distance between the invading cutting line and the margin line. Cutting has to be performed close to a dotted line because the minimum distance has a narrow width, but the cutting is not performed close to the dotted line.

In contrast, FIG. 1(a) shows a clearly cut sawing line 3, and FIG. 1(b) shows a state in which a cut portion is partially fallen off in the form of a groove 26. This is a diamond cutting defect. In this case, whether or not to use a chip produced through a test is determined by checking this defect. More particularly, an image of the sawing line 3 is obtained, a substantial width of the sawing line 3 is tested, and whether there is a defect in the chip 20 or not is tested by measuring ‘A’ and ‘B’.

Furthermore, the above problem also has an error in that an image of a cut product cannot be precisely obtained. In the case of the groove 26 fallen off from the drawing, it is difficult to obtain a precise image of the groove 26 by deriving the scattering of light. In particular, in the case of coaxial illumination, this phenomenon becomes severe. There is a portion that is not substantially radiated by light because the light is incident in one direction and emitted to the sawing line 3, that is, the subject of measurement. This results in a problem in a precise test because light is not emitted or a shadow area that derives diffused reflection is generated.

The sawing line of a wafer has been chiefly described so far. However, a groove may have a protruding form like the sawing line 3, that is, the subject of measurement. In the case of a very minute protrusion, if illumination is not perfect, shade or a shadow is generated. As a result, there is a disadvantage in that a precise test becomes difficult because a precise image cannot be obtained.

### PRIOR ART DOCUMENT

### Patent Document

Korean Patent Registration No. 10-0978487

### SUMMARY OF THE INVENTION

The present invention has been made keeping in mind the above problems occurring in the prior art, and an object of the present invention is to provide lighting apparatus for providing illumination light, which is capable of obtaining a clear image of a processed part in order to check whether or not there is a defect in the processed part in a process of producing a variety of electronic parts or materials. In particular, an object of the present invention is to provide lighting apparatus provided to a photographing apparatus so that a minute scar, a crack, chipping, and a defect in a processing part (i.e., a sawing line) formed by a diamond sawing process for cutting a semiconductor wafer can be easily tested.

Another object of the present invention is to provide a test apparatus having high reliability and a precise production function by providing the test apparatus capable of testing the sawing line of a wafer by using the above-described lighting apparatus.

In order to achieve the above objects, the present invention provides lighting apparatus for measuring an electronic material-processed part of the subject of measurement and illuminating the processing part, including a dome reflection plate 12 disposed over the subject of measurement and configured to have a dome form, have a light inflow window 11 through which coaxial illumination enters or exits formed at the central part of the highest end of the dome reflection plate 12, and have incident light reflected in all directions within the dome; a plurality of dome illumination lamps 13 disposed at lower edge portions of the dome reflection plate 12 and configured to illuminate the inside of the dome; and a camera 20 disposed right over the light inflow window 11 for the coaxial illumination of the dome reflection plate 12.

Furthermore, uniform illumination light is provided to bends in a surface of the subject of measurement by controlling the coaxial illumination and background illumination separately or simultaneously.

Furthermore, the dome reflection plate 12 having an inner circumferential face that forms the dome is formed of a reflection plate having a semicircular sphere, an oval figure, or a radius of curvature so that light projected to the dome reflection plate 12 is radiated internally in all directions.

The lighting apparatus further includes reflection mirrors disposed under the dome illumination lamps and configured to reflect illumination light toward the subject of measurement again.

The lighting apparatus further includes a light transmission room 14 disposed over the dome reflection plate 12; coaxial illumination lamps 15 provided on one side within the light transmission room 14 and configured to radiate light in one direction; and an optical splitter 16 disposed right over the light inflow window 11 and configured to transmit some of the light radiated from the coaxial illumination lamps 15 and reflect some of the radiated light, wherein some of the light radiated from the coaxial illumination lamps 15 pass through the optical splitter 16 and some of the radiated light are reflected from the optical splitter 16 so that the subject of measurement is illuminated through the light inflow window 11.

In order to achieve the above objects, the present invention provides lighting apparatus for measuring an electronic material-processed part, including a dome reflection plate 12 disposed over the subject of measurement and configured to have a dome form, have a light inflow window 11 through which coaxial illumination enters or exits formed at the central part of the highest end of the dome reflection plate 12, and have incident light reflected in all directions within the dome; and a plurality of dome illumination lamps 13 disposed at lower edge portions of the dome reflection plate 12 and configured to illuminate the inside of the dome.

In order to achieve the above objects, the present invention provides a test apparatus using lighting apparatus for measuring an electronic material-processed part, including horizontal transfer means 30 configured to horizontally transfer a zig 31 in which a wafer to be tested is seated; lighting apparatus 50 dispose over the zig 31 of the horizontal transfer means 30, configured to radiate illumination light to sawing lines of the wafer, and configured to comprise a dome reflection plate 12 disposed over a subject of measurement and configured to have a dome form and have a light inflow window 11 for coaxial illumination formed at the central part of the highest end of the dome reflection plate 12, a plurality of dome illumination lamps 13 disposed at lower edge portions of the dome reflection plate 12 and configured to illuminate the inside of the dome, and a camera 20 disposed right over the light inflow window 11 for the coaxial illumination of the dome reflection plate 12; and an auto-focusing unit configured to control focusing on an image obtained by the camera through the illumination light, wherein an image of the sawing line is obtained by controlling the horizontal transfer means, the lighting apparatus, and the auto-focusing unit and whether or not there is a defect in the sawing line is tested.

Furthermore, the dome reflection plate 12 having an inner circumferential face that forms the dome is formed of a reflection plate having a semicircular sphere, an oval figure, or a radius of curvature so that light projected to the dome reflection plate 12 is radiated internally in all directions.

The test apparatus further includes a light transmission room 14 disposed over the dome reflection plate 12; coaxial illumination lamps 15 provided on one side within the light transmission room 14 and configured to radiate light in one direction; and an optical splitter 16 disposed right over the light inflow window 11 and configured to transmit some of the light radiated from the coaxial illumination lamps 15 and reflect some of the radiated light, wherein some of the light radiated from the coaxial illumination lamps 15 pass through the optical splitter 16 and some of the radiated light are reflected from the optical splitter 16 so that the subject of measurement is illuminated through the light inflow window 11.

Furthermore, uniform illumination light is provided to bends in a surface of the subject of measurement by controlling the coaxial illumination and background illumination separately or simultaneously.

### BRIEF DESCRIPTION OF THE DRAWINGS

FIG. 1 is a cross-sectional view showing a problem of a cutting defect that is generated at the cut processing part of a wafer,

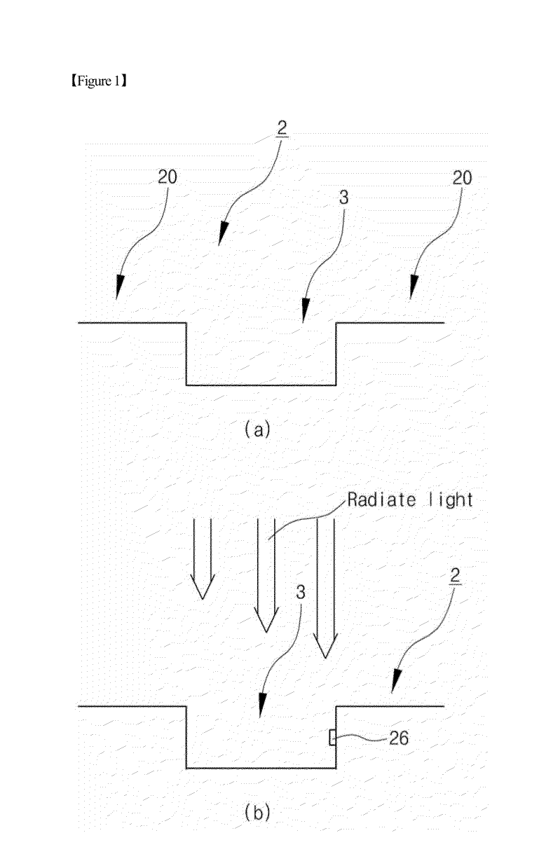

FIG. 2 is a diagram showing that an image of a cut processing part is obtained and image processing is performed,

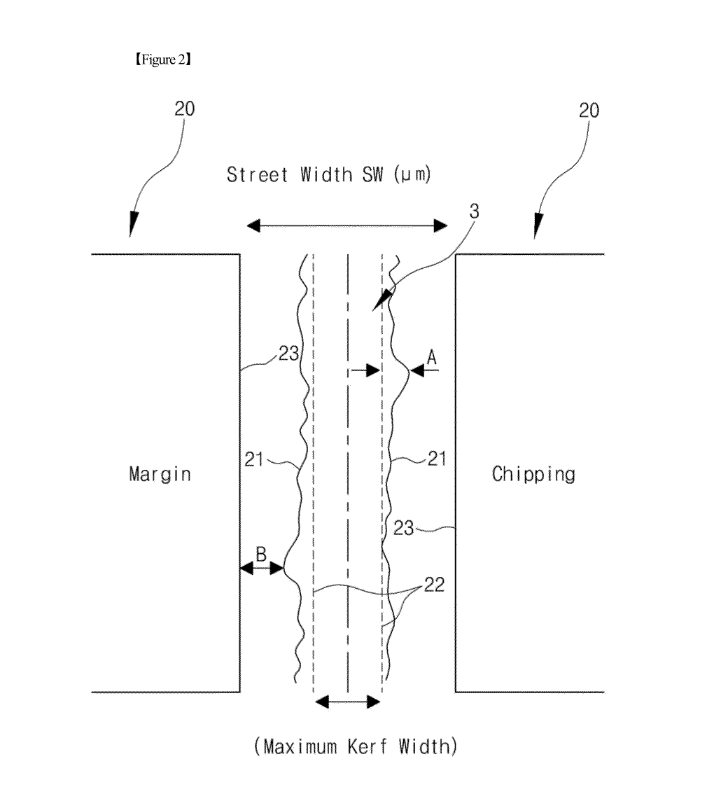

FIG. 3 shows an image of an actually measured processing part,

FIG. 4 is a diagram showing that a wafer is processed into chips in accordance with the present invention,

FIG. 5 is a cross-sectional view showing lighting apparatus for measuring an electronic material-processed part in accordance with the present invention,

FIG. 6 is a detailed cross-sectional view of a dome lighting apparatus in accordance with the present invention,

FIG. 7 shows a general construction of a test apparatus using the lighting apparatus for measuring an electronic material-processed part in accordance with the present invention,

FIG. 8 shows a schematic construction of a test apparatus using the lighting apparatus for measuring an electronic material-processed part in accordance with the present invention, and

FIG. 9 shows an image of a sawing line obtained by the lighting apparatus in accordance with the present invention.

### DETAILED DESCRIPTION

Lighting apparatus for measuring an electronic material-processed part and a test apparatus using the same in accordance with some exemplary embodiments of the present invention are described in detail below with reference to the accompanying drawings.

The lighting apparatus for measuring an electronic material-processed part in accordance with the present invention is configured to have a dome form in such a way as to be placed over the subject of measurement and configured to include a light inflow window 11 formed at the central part of the highest end of the lighting apparatus so that coaxial illumination can enter or exit from the light inflow window 11, a dome reflection plate 12 configured to reflect incident light in all directions, a plurality of dome illumination lamps 13 disposed at lower edge portions of the dome reflection plate 12 and configured to illuminate the inside of the dome, and a camera 20 disposed right over the light inflow window 11 for the coaxial illumination of the dome reflection plate 12 so that the processing part of the subject of measurement is illuminated and the test apparatus using the same.

In the lighting apparatus for measuring an electronic material-processed part and the test apparatus using the same in accordance with the present invention, the lighting apparatus is configured to have a dome form in order to provide uniform illumination light to a processing part corresponding to the sawing line of a wafer, the reflection light of the sawing line obtained by the dome lighting apparatus is obtained by the test apparatus, and whether or not there is a defect in a wafer chip according to the sawing line or whether a wafer chip is normal or not is checked based on the obtained reflection light. In other words, the present invention relates to the lighting apparatus for providing illumination light to a sawing line that is formed during diamond sawing processing performed on a wafer and the test apparatus using the lighting apparatus. The constructions and operations of the present invention are described in detail with reference to the accompanying drawings.

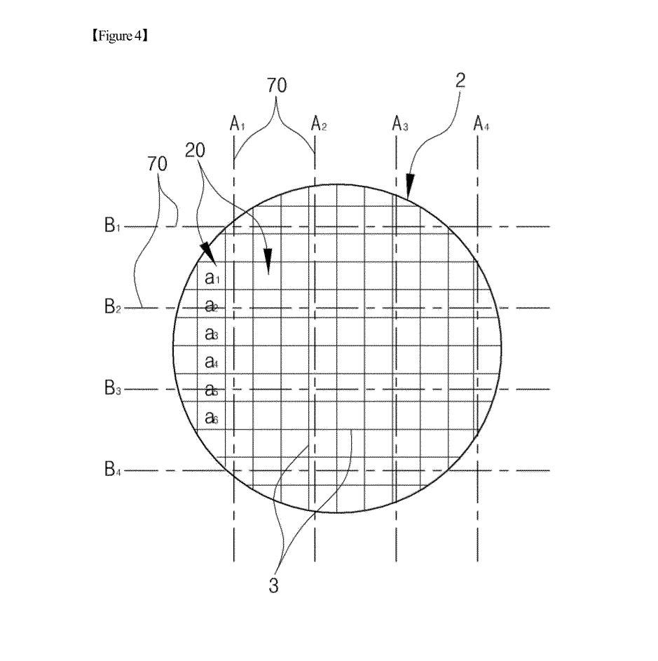

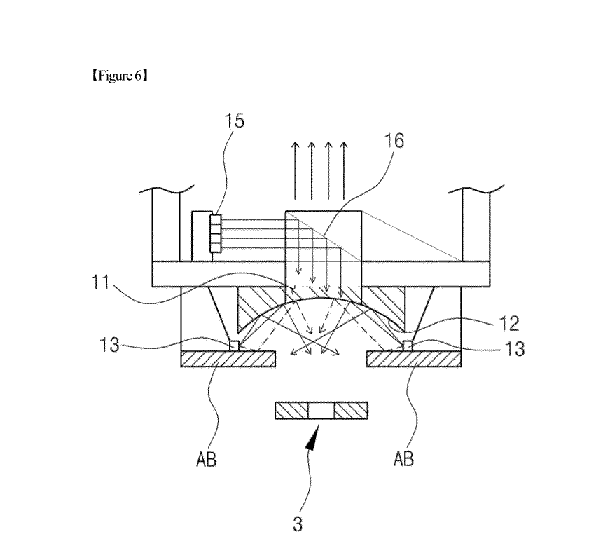

FIG. 4 is a diagram showing that a wafer is processed into chips. When a specific region of a wafer 2 is split and scanned, focusing has to be performed. A concept of the focusing is shown in FIG. 6. After the wafer 2 is fabricated, the wafer 2 is cut into chips 20 in a proper size. As shown in FIG. 4, cut sawing lines 3 are formed. However, it is inconvenient to test a product by scanning all the chips 20 one by one. A process is complicated because the scanning process is performed too many, and it is not necessary to obtain an image of a chip part because a product is tested by obtaining an image of the sawing lines 3. In the present invention, in order to solve the problems, division lines 70 are separately drawn as shown in FIG. 4. An interval between the division lines 70 is wider than one chip because an image of the sawing lines 3 is obtained. The division lines 70 are formed in such a way as to cross the chip parts. The division lines 70 are virtualized so that the sawing lines 3 are cut. The division lines 70 are lines that are recognized by a camera P, but are not actually seen. When the division lines 70 are partitioned, focusing on the part of the division lines is scanned.

In the present invention, auto-focusing is first performed, scanning is performed, and an image is obtained, but the following method is used. That is, a method of dividing a specific region of the wafer 2 into parts and scanning the parts includes partitioning the wafer 2 into the division lines (i.e., virtual lines) 70, having a wider area than chips partitioned by the sawing lines 3, in a square form, performing focusing scanning, and obtaining an image while performing focusing compensation by using a focusing value as a reference value.

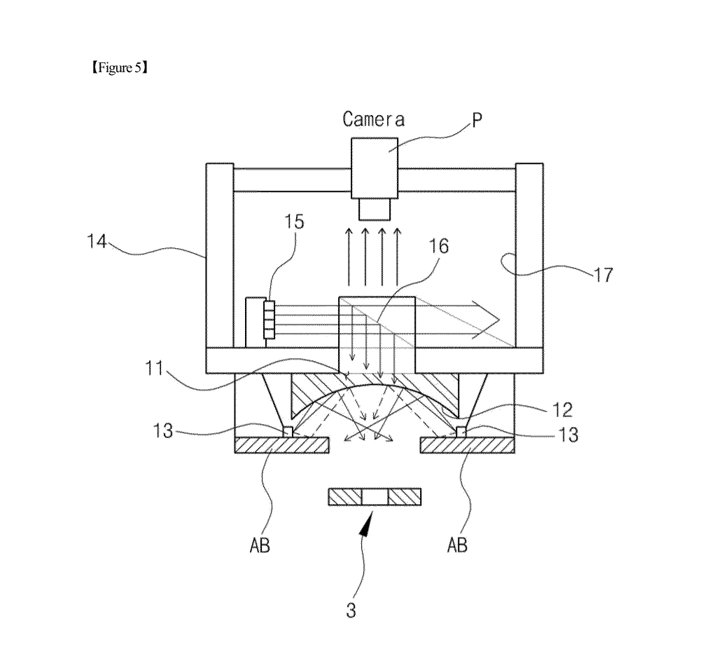

FIG. 5 is a cross-sectional view showing lighting apparatus for measuring an electronic material-processed part in accordance with the present invention, and FIG. 6 is a detailed cross-sectional view of a dome lighting apparatus in accordance with the present invention.

First, the lighting apparatus for measuring an electronic material-processed part is described below.

The lighting apparatus in accordance with the present invention is configured to have a dome form in such a way as to cover the top of the subject of measurement and to include a dome reflection plate 12 configured to have a light inflow window 11 for coaxial illumination formed at the central part of the highest end of the dome reflection plate 12 so that light reflects into the dome and a plurality of dome illumination lamps 13 disposed at lower edge portions of the dome reflection plate 12 so that the sawing lines 3 of the wafer 2 are precisely illuminated.

That is, the lighting apparatus of the present invention is configured to radiate background illumination in multiple directions so that an optimal image of a sawing line can be obtained, for example, when testing whether or not there is a defect in the chip 20 cut from the wafer 2.

The sawing line 3, that is, the subject of measurement, is placed under the dome reflection plate 12, and the sawing line 3 is placed so that it can receive light reflected from the dome reflection plate 12 in all directions. The light inflow window 11 is formed at the top of the dome reflection plate 12 as shown in FIG. 5, the dome reflection plate 12 is configured to entirely surround the sawing line 3 of the wafer 2, that is, the subject of measurement, and the dome illumination lamps 13 are installed at lower edge portions of the dome reflection plate 12. When the dome illumination lamps 13 disposed at the lower edge portions of the dome reflection plate 12 are turned on, light of the turned-on lamps is radially spread out in all directions. For example, light that is emitted from the dome illumination lamps 13 and then raised lights up the dome reflection plate 12. Next, the light is reflected and lowered at a specific angle. Next, the light lights up the sawing line 3. Furthermore, when light from the dome illumination lamps 13 is radially spread out, reflection mirrors AB placed under the dome illumination lamps 13 reflects the light that is lowered to the bottom and switches the light to the dome reflection plate 12 on the upper side.

Next, the light is reflected from the dome reflection plate 12 again and lowered. Next, the light lights up the sawing line 3 on the lower side. A shadow is not generated because the light is emitted in all directions. In the present invention,

FIG. 6 shows a state in which the dome illumination lamps 13 emit light radially and some of the emitted light is raised up, directly rushed toward the dome reflection plate 12, reflected, and then directed toward the sawing line 3 as indicated by the direction of a solid arrow. In contrast, when the dome illumination lamps 13 emit light radially, the emitted light is lowered to the reflection mirrors AB on the lower side, reflected, raised, and then lowered again via the dome reflection plate 12 as indicated by the direction of an arrow having a different from the solid arrow. As a result, the lighting apparatus of the present invention is effective in being utilized as background illumination for the sawing line 3 of a wafer because it radiates light in all direction, unlike a conventional lighting apparatus.

More detailed embodiments of the present invention are described below.

The dome reflection plate 12 having an inner circumferential face that forms a dome preferably is formed of a reflection plate having a semicircular sphere, an oval figure, or a variety of the radii of curvature so that projected light is emitted internally in all directions. That is, the dome reflection plate 12 of the present invention is a reflection plate configured to reflect emitted light internally and radiate the light in all directions. This action is not achieved by only the dome reflection plate 12 that forms the inner circumferential face having a semicircular form, but can be achieved by an elliptical dome reflection plate 12. Light generally lights up the inside of the dome reflection plate 12 because the dome reflection plate 12 having some degree of radius of curvature can reflect emitted light internally in all directions.

In the present invention, the dome reflection plate 12 is illustrated to have the inner circumferential face having a semicircular sphere, but the present invention is not limited thereto. As described above, the inner circumferential face of the dome reflection plate 12 can be fabricated to have an oval figure or a variety of radii of curvature. It is preferred that the sawing line 3 to which light has to be radiated by using background illumination be illuminated by the dome reflection plate 12 so that the background illumination can be performed optimally by controlling the radius of curvature depending on a form of the sawing line 3.

Furthermore, the dome reflection plate 12 can have one block the inside of which has a dome form or a plurality of blocks that are assembled together. The inner circumferential face of one block can be fabricated to have a dome form, but a plurality of blocks or a plurality of panels can be coupled and assembled into the dome reflection plate 12 having one dome form in order to facilitate assembly and maintenance.

Furthermore, the reflection mirrors AB are installed under the dome reflection plate 12 so that light can be emitted in all directions. As shown in FIGS. 5 and 6, light from coaxial illumination lamps 15 is downwardly reflected by an optical splitter 16, the light vertically lights up the wafer through the light inflow window 11, and light reflected from a surface of the wafer is introduced into the camera P through the light inflow window 11 and the optical splitter 16 again.

Furthermore, light of the dome illumination lamps 13 lights up the dome reflection plate 12, light scatted by the dome reflection plate 12 lights up a surface of the wafer uniformly, and light reflected from the surface of the wafer is introduced into the camera P through the light inflow window 11 and the optical splitter 16 again.

That is, a vertical coaxial illumination effect can be expected by way of the coaxial illumination lamps 15, and a scattered dome illumination effect can be expected by way of the dome illumination lamps 13. An image having a uniform and clear shade and shadow, of a wafer sawing line having a bent surface, can be obtained by selectively combining the two types of illumination lamps.

Meanwhile, in accordance with the present invention, a light transmission room 14 is formed over the dome reflection plate 12, the coaxial illumination lamps 15 for radiating light in one direction are disposed on one side inside the light transmission room 14. Furthermore, the optical splitter 16 is disposed right on the light inflow window 11 and is configured to receive light from the coaxial illumination lamps 15 and transmit some of the received light, but reflect some of the received light. Accordingly, light emitted from the coaxial illumination lamps 15 is partially transmitted and partially reflected by the optical splitter 16, so that the light can light up the subject of measurement via the light inflow window 11 on the lower side.

The subject of measurement is first lighted up by background illumination in order to fully block a shadowy part and coaxial illumination is then entered through the dome reflection plate 12 in order to obtain a clearer image. The light transmission room 14 for producing a secret room effect is formed over the dome reflection plate 12, and the coaxial illumination lamps 15 are mounted on one side of the light transmission room 14. The coaxial illumination lamps 15 are installed in such a way as to emit light in one direction. The coaxial illumination lamps 15 function to radiate light toward the optical splitter 16 that is placed right on the light inflow window 11 at the central part of the light transmission room 14, that is, in the middle of the dome reflection plate 12.

When the coaxial illumination lamps 15 emit light, the light goes straight on and collides against the optical splitter 16. The optical splitter 16 is a lens that transmits some of the emitted light, but reflects the remaining light. Accordingly, the light of the coaxial illumination lamps 15 goes straight on and has two paths when it collides against the optical splitter 16. In one of the two paths, some of the light is transmitted and absorbed by the wall 17 of the light transmission room 14. In the other of the two paths, some of the light is reflected from the optical splitter 16, and the reflected light enters the light inflow window 11 of the dome reflection plate 12 and lights up the sawing line 3 on the lower side. The emitted light upwardly goes straight on again and enters the lens of the camera P. The entered light is read by the sensor of the camera P, and thus an image of the light is obtained. In the present invention, first, the sawing line 3 of the wafer, that is, the subject of measurement, is entirely illuminated by background illumination so that a shadow is removed and a sharp image is obtained. Here, in order to obtain an image, coaxial illumination is also important. Accordingly, coaxial illumination using the optical splitter 16 is also used because only light that collides against the subject of measurement and then returns to the sensor of the camera P helps to obtain an image.

Meanwhile, in order to improve quality in obtaining an image, the wall 17 of the light transmission room 14 of the present invention includes light-blocking means for blocking the emission of light. When some of light that pass through the optical splitter 16 collide against the wall 17 of the light transmission room 14 and thus generate diffused reflection, there is a possibility that the quality of an image may be deteriorated. In the present invention, in order to solve this problem, the light-blocking means is provided in the wall 17 of the light transmission room 14 and subjected to coating or printing processing, such as black color processing. This is because black color absorbs light and does not generate diffused reflection. In some embodiments, a variety of other methods may be used.

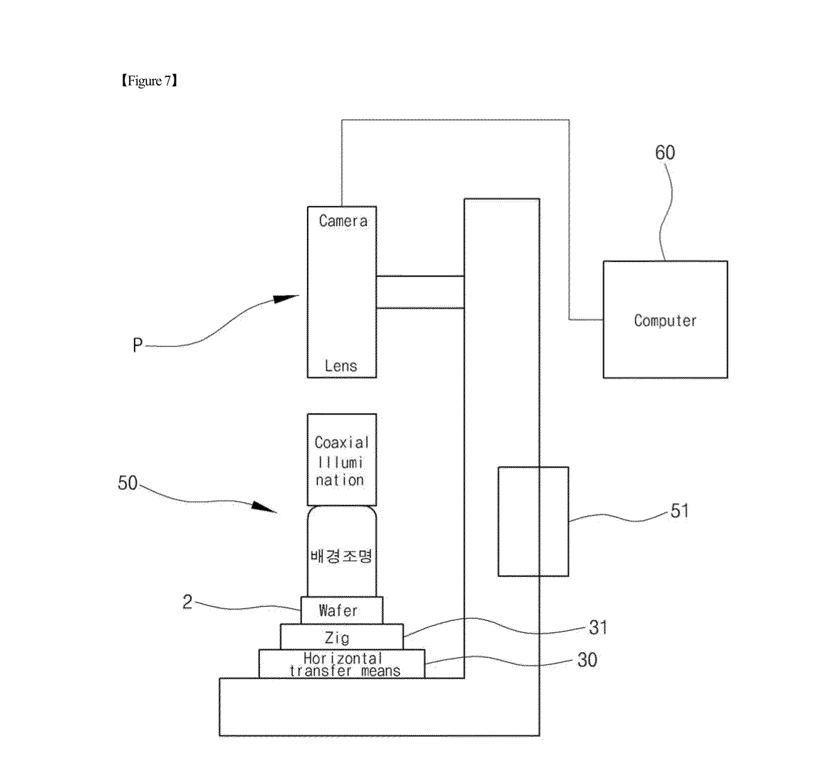

Furthermore, in the present invention, the optical splitter 16 is an optical apparatus for reflecting 30-70% of incident light, but transmitting the remaining light. The optical splitter 16 transmits some of radiated light, but reflects the remaining light, so that the light enters the light inflow window 11 in a downward straight-line direction. Most preferably, the optical splitter 16 reflects 50% of light radiated from the coaxial illumination lamps 15 and transmits 50% of the radiated light. If, as shown in FIGS. 6 and 7, about 50% of the radiated light travels under the light inflow window 11 right under the dome reflection plate 12, lights up the sawing line 3, reflects upwardly again, and then reaches the optical splitter 16 via the light inflow window 11, only about 50% of the returned light rises and then enters the lens of the camera P. Thus, the light becomes substantially light incident to the image sensor of the camera P. If this method is used, the clearest image can be obtained.

In general, in accordance with experiments performed by the applicant of the present invention, to use the optical splitter 16 for reflecting about 30-70% of incident light and transmitting the remaining light was preferred.

A test apparatus including the lighting apparatus is described in detail below.

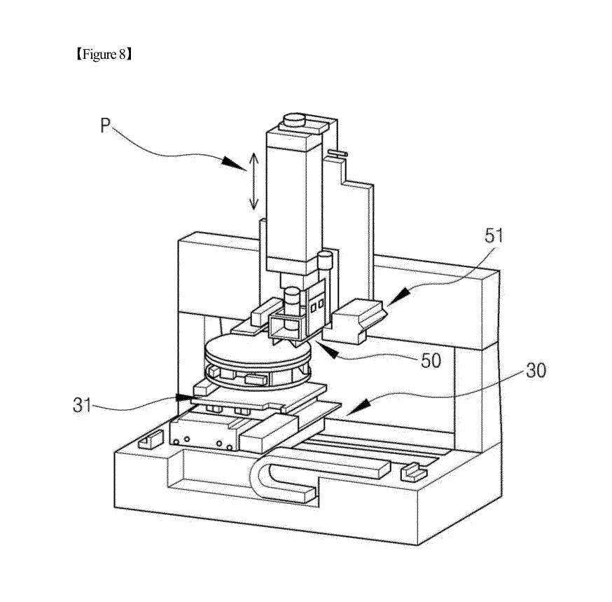

FIG. 7 shows a general construction of the test apparatus using the lighting apparatus for measuring an electronic material-processed part in accordance with the present invention, and FIG. 8 shows a schematic construction of the test apparatus using the lighting apparatus for measuring an electronic material-processed part in accordance with the present invention.

As shown, the test apparatus of the present invention is equipped with the lighting apparatus, the camera P, an auto-focus unit 51, and an operation unit (i.e. PC) 60. The lighting apparatus illuminates the sawing line of a wafer, that is, the subject of measurement. When the camera P captures an image of the light, the auto-focus unit 51 performs focusing. The obtained data or image is read by the operation unit (i. e., PC) 60 in order to check whether there is a defect in the wafer or not.

As shown in FIGS. 5 to 7, the test apparatus of the present invention includes horizontal transfer means 30 configured to horizontally transfer a zig 31 in which a wafer 2 to be tested is seated and the lighting apparatus 50 configured to include the dome reflection plate 12 disposed over the zig 31 of the horizontal transfer means 30 and configured to have a dome form so that the dome reflection plate 12 is disposed over the subject of measurement, have the light inflow window 11 for coaxial illumination formed at the central part of the top thereof, and have light reflected into the inside of the dome, a plurality of the dome illumination lamps 13 installed at the lower edge portions of the dome reflection plate 12 and configured to have light radiated into the inside of the dome, the dome illumination lamps 15 for coaxial illumination, the optical splitter 16, and the camera P disposed right over the lighting apparatus 50 and configured to precisely illuminate the sawing line 3 of the wafer 2. The test apparatus of the present invention further includes the operation unit 60 for calculating whether or not there is a defect in the sawing line 3 of the wafer 2 by checking obtained image data. Accordingly, a defect generated when cutting the sawing line 2 of the wafer 2 can be tested.

That is, the horizontal transfer means 30 is configured to horizontally precisely move the zig 31 seated in the wafer 2 and move the sawing line 3 of the wafer 2 whose image will be scanned in the direction of the lens. A variety of devices can be used as the horizontal transfer means 30. Horizontal movement having ultra-high precision can be achieved by a robot actuator. Furthermore, the lighting apparatus 50 of the present invention and the camera P are mounted over the zig 31. An image of the sawing line 3 of the wafer 2 mounted on the zig 31 is obtained and whether or not there is a defect in the sawing line 3 is detected.

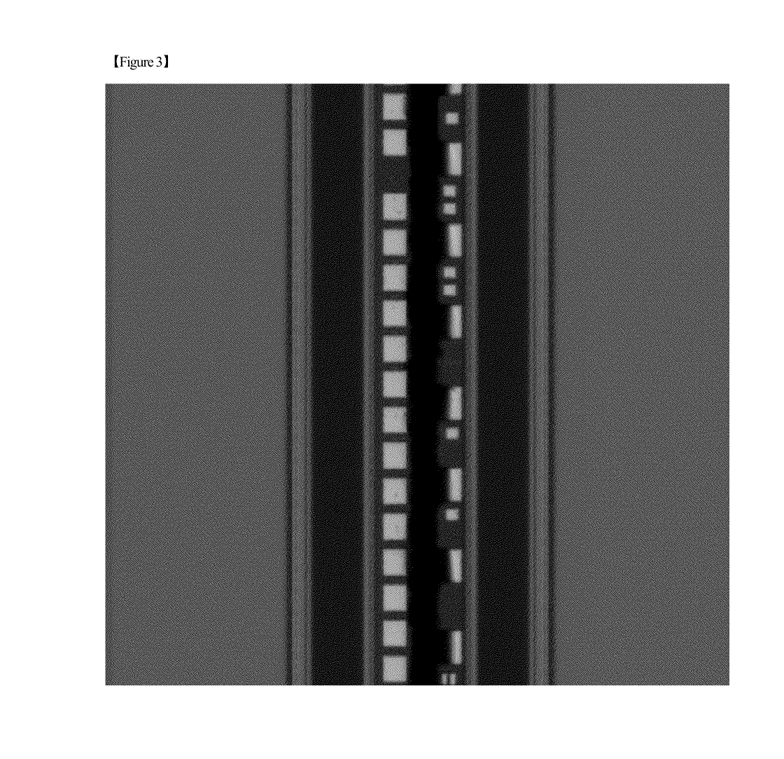

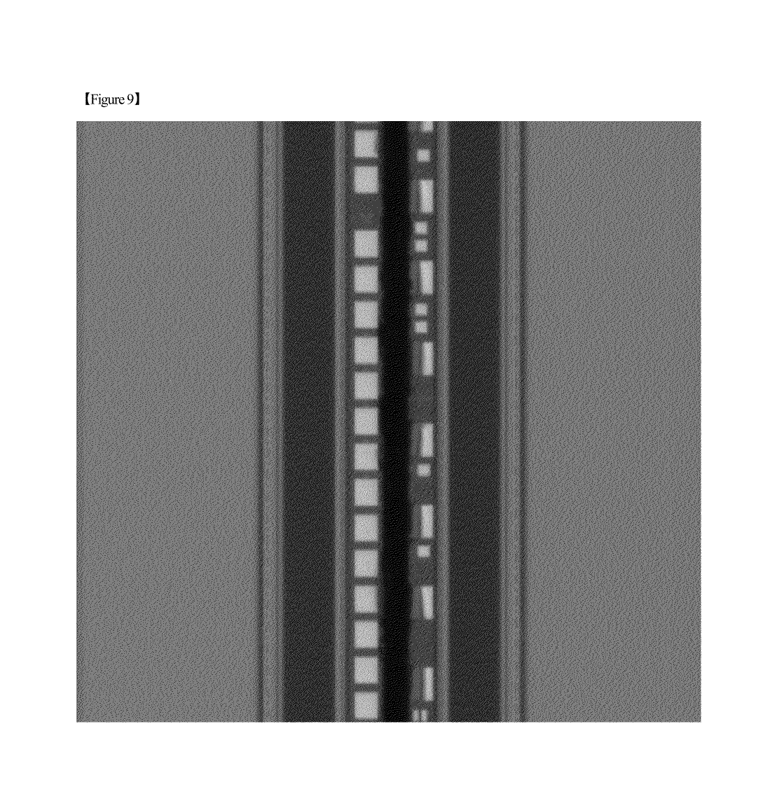

FIG. 9 shows an image of a sawing line obtained by the lighting apparatus in accordance with the present invention. FIG. 9 shows an image obtained by the dome reflection plate 12 of the present invention in the state in which background illumination is performed. As clearly shown in FIG. 9 as compared with FIG. 3, when an image is obtained by the lighting apparatus of the present invention, it can be seen that a shape of the sawing line 3 can be recognized and easily checked.

Furthermore, in the present invention, in order to obtain an image by using the lighting apparatus of the present invention, the auto-focus unit 51 is mounted. The auto-focus unit 51 equipped with up and down moving means is mounted on one side of the test apparatus and configured to focus the lens and the camera P according to the level of the subject of measurement. That is, when a portion of the wafer 2 to be scanned is selected by performing horizontal movement, the camera P and the lens are moved and positioned so that they are focused. This ultra-high operation is achieved by the auto-focus unit 51 mounted on the side of the camera P in the present invention. The auto-focus unit 51 chiefly moves the lens, thereby increasing the degree of accuracy of an image obtained by the camera P. If this focusing process is not used, the degree of accuracy of an image obtained by the camera P of the present invention will be low.

As described above, the present invention is advantageous in that it has a high degree of accuracy because images of a variety of electronic parts, such as a device having a micro unit size, a processing part, a cut groove, and a connected protruding part, are obtained by using background illumination in the state the variety of electronic parts are generally illuminated.

Furthermore, in accordance with the present invention, a shadow is not generated in the subject of measurement within the dome because the dome reflection plate and the dome illumination lamps having simple constructions are used. Accordingly, there are advantages in that an obtained image is precise and a shape of the image can be precisely determined and whether or not there is a bend or groove in the image can be precisely determined by way of image processing.

As a result, in accordance with the present invention, a plurality of blocks or panels is assembled so that an image of a processing part, such as a variety of minute grooves, cutting parts, and connection parts, and protrusions, can be easily obtained and the dome reflection plate having a controllable radius of curvature is provided. Accordingly, there are advantages in that utilization is high and an electronic material or a part can be precisely tested.

What is claimed is:

1. Lighting apparatus for measuring an electronic material-processed part of a subject of measurement and illuminating the processing part, the lighting apparatus comprising:
a dome reflection plate 12 disposed over the subject of measurement and configured to have a dome form, have a light inflow window 11 through which coaxial illumination enters or exits formed at a central part of a highest end of the dome reflection plate 12, and have incident light reflected in all directions within the dome;
a plurality of dome illumination lamps 13 disposed at lower edge portions of the dome reflection plate 12 and configured to illuminate the inside of the dome; and
a camera 20 disposed right over the light inflow window 11 for the coaxial illumination of the dome reflection plate 12.

2. The lighting apparatus of claim 1, wherein uniform illumination light is provided to bends in a surface of the subject of measurement by controlling the coaxial illumination and background illumination separately or simultaneously.

3. The lighting apparatus of claim 1, wherein the dome reflection plate 12 having an inner circumferential face that forms the dome is formed of a reflection plate having a semicircular sphere, an oval figure, or a radius of curvature so that light projected to the dome reflection plate 12 is radiated internally in all directions.

4. The lighting apparatus of claim 1, further comprising reflection mirrors disposed under the dome illumination lamps and configured to reflect illumination light toward the subject of measurement again.

5. The lighting apparatus of claim 1, further comprising:
a light transmission room 14 disposed over the dome reflection plate 12;
coaxial illumination lamps 15 provided on one side within the light transmission room 14 and configured to radiate light in one direction; and
an optical splitter 16 disposed right over the light inflow window 11 and configured to transmit some of the light radiated from the coaxial illumination lamps 15 and reflect some of the radiated light,
wherein some of the light radiated from the coaxial illumination lamps 15 pass through the optical splitter 16 and some of the radiated light are reflected from the optical splitter 16 so that the subject of measurement is illuminated through the light inflow window 11.

6. Lighting apparatus for measuring an electronic material-processed part, the lighting apparatus comprising:
a dome reflection plate 12 disposed over the subject of measurement and configured to have a dome form, have a light inflow window 11 through which coaxial illumination enters or exits formed at a central part of a highest end of the dome reflection plate 12, and have incident light reflected in all directions within the dome; and
a plurality of dome illumination lamps 13 disposed at lower edge portions of the dome reflection plate 12 and configured to illuminate the inside of the dome.

7. A test apparatus using lighting apparatus for measuring an electronic material-processed part, the test apparatus comprising:
horizontal transfer means 30 configured to horizontally transfer a zig 31 in which a wafer to be tested is seated;
lighting apparatus 50 dispose over the zig 31 of the horizontal transfer means 30, configured to radiate illumination light to sawing lines of the wafer, and configured to comprise a dome reflection plate 12 disposed over a subject of measurement and configured to have a dome form and have a light inflow window 11 for coaxial illumination formed at a central part of a highest end of the dome reflection plate 12, a plurality of dome illumination lamps 13 disposed at lower edge portions of the dome reflection plate 12 and configured to illuminate the inside of the dome, and a camera 20 disposed right over the light inflow window 11 for the coaxial illumination of the dome reflection plate 12; and
an auto-focusing unit configured to control focusing on an image obtained by the camera through the illumination light,
wherein an image of the sawing line is obtained by controlling the horizontal transfer means, the lighting apparatus, and the auto-focusing unit and whether or not there is a defect in the sawing line is tested.

8. The test apparatus of claim 7, wherein the dome reflection plate 12 having an inner circumferential face that forms the dome is formed of a reflection plate having a semicircular sphere, an oval figure, or a radius of curvature so that light projected to the dome reflection plate 12 is radiated internally in all directions.

9. The test apparatus of claim 7, further comprising:
a light transmission room 14 disposed over the dome reflection plate 12;
coaxial illumination lamps 15 provided on one side within the light transmission room 14 and configured to radiate light in one direction; and
an optical splitter 16 disposed right over the light inflow window 11 and configured to transmit some of the light radiated from the coaxial illumination lamps 15 and reflect some of the radiated light,
wherein some of the light radiated from the coaxial illumination lamps 15 pass through the optical splitter 16 and some of the radiated light are reflected from the optical splitter 16 so that the subject of measurement is illuminated through the light inflow window 11.

10. The test apparatus of claim 7, wherein uniform illumination light is provided to bends in a surface of the subject of measurement by controlling the coaxial illumination and background illumination separately or simultaneously.
